(19) United States
(12) Patent Application Publication
(10) Pub. No.: US 2024/0344203 A1
(43) Pub. Date: Oct. 17, 2024

(54) COATED MAGNETIC MATERIAL AND METHOD OF PRODUCING COATED MAGNETIC MATERIAL

(71) Applicant: NICHIA CORPORATION, Anan-shi (JP)

(72) Inventors: Satoshi ABE, Tokushima-shi (JP); Ryoya OKAZAKI, Anan-shi (JP); Jun AKAMATSU, Tokushima-shi (JP); Nobuyoshi IMAOKA, Anan-shi (JP); Masahiro ABE, Tokushima-shi (JP)

(73) Assignee: NICHIA CORPORATION, Anan-shi (JP)

(21) Appl. No.: 18/633,804

(22) Filed: Apr. 12, 2024

(30) Foreign Application Priority Data
Apr. 14, 2023 (JP) 2023-066601

(51) Int. Cl. C23C 22/07; B22F 1/16; B22F 1/17; B22F 3/16; C23C 22/82; H01F 1/053; H01F 41/02

(52) U.S. Cl. CPC C23C 22/07; B22F 1/16; B22F 1/17; B22F 3/16; C23C 22/82; H01F 1/053; H01F 41/0266; B22F 2301/35; B22F 2998/10

(57) ABSTRACT

A method of producing a coated magnetic material, including: a coating procedure including mixing a soft magnetic material and an aqueous solution containing a phosphate compound and a rare earth compound to form a coating containing a phosphorus compound containing a rare earth metal element on a surface of the soft magnetic material.

### CROSS-REFERENCE TO RELATED PATENT APPLICATION

This application claims priority to Japanese Patent Application No. 2023-066601 filed on Apr. 14, 2023. The disclosure of Japanese Patent Application No. 2023-066601 is hereby incorporated by reference in its entirety.

### BACKGROUND

The present disclosure relates to a coated magnetic material and a method of producing such a coated magnetic material.

Powder magnetic cores molded from soft magnetic powders are used as magnetic core materials for motors, transformers, and other electrical equipment. When a soft magnetic powder is molded as it is, eddy currents can be generated throughout the resulting component due to conduction between the powder particles, resulting in higher iron loss. Japanese Patent publication No. 2011-127201 discloses a method of forming a coating containing hydroxyapatite on the surface of a soft magnetic powder in order to reduce iron loss in the resulting powder magnetic core. Japanese Patent Publication No. H06-132109 discloses a method of forming a glassy insulating layer containing Cr or P as an essential element on the surface of a soft magnetic powder.

### SUMMARY

Embodiments of the present disclosure aim to provide a method of producing a magnetic material having a coating with good heat resistance.

An exemplary embodiment of the present disclosure relates to a method of producing a coated magnetic material, including: a coating procedure including mixing a soft magnetic material and an aqueous solution containing a phosphate compound and a rare earth compound to form a coating containing a phosphorus compound containing a rare earth metal element on a surface of the soft magnetic material.

An exemplary embodiment of the present disclosure relates to a coated magnetic material, including: a soft magnetic material; and a coating containing a rare earth metal element, phosphorus, and oxygen provided on a surface of the soft magnetic material.

The embodiments of the present disclosure can provide a method of producing a magnetic material having a coating with good heat resistance.

### BRIEF DESCRIPTION OF DRAWINGS

FIG. 1 shows a scanning transmission electron microscope (STEM) image of a coated magnetic material produced in Example 10.

FIG. 2 shows line scan results of the coated magnetic material produced in Example 10.

FIG. 3 shows line scan results of the coated magnetic material produced in Example 10.

FIG. 4A is a Mn distribution chart measured by STEM-EDX analysis of a coated magnetic material produced in Example 16.

FIG. 4B is a histogram showing the distribution of Mn content in the coated magnetic material produced in Example 16.

### DETAILED DESCRIPTION

Embodiments of the present disclosure are described in detail below. The following embodiments, however, are intended as examples to embody the technical idea of the present invention and are not intended to limit the scope of the present invention to the following embodiments. As used herein, the term “procedure” encompasses not only an independent procedure but also a procedure that may not be clearly distinguished from other procedures, as long as a desired object of the procedure is achieved. Moreover, numerical ranges indicated using “to” refer to ranges including the numerical values before and after “to” as the minimum and maximum, respectively.

### Method of Producing Coated Magnetic Material

A method of producing a coated magnetic material according to the present embodiments includes a coating procedure including mixing an aqueous solution containing a phosphate compound and a rare earth compound with a magnetic material that is a soft magnetic material to form a coating containing a phosphorus compound containing a rare earth metal element on a surface of the magnetic material.

### Magnetic Material

In the present embodiments, a soft magnetic material is used as a magnetic material. The soft magnetic material is a material with low coercivity and high saturation flux density. Examples of the soft magnetic material include oxide-based soft magnetic materials and metal-based soft magnetic materials. The soft magnetic material can be a material with a coercivity of not more than 10 Oe (795.8 A/m) and a saturation flux density of at least 0.3 T. The soft magnetic material can be a material with a coercivity of not more than 5 Oe (397.9 A/m) and a saturation flux density of at least 1.0 T.

Examples of the oxide-based soft magnetic materials include materials containing an iron oxide and a transition metal such as Ni, Zn, Cu, Mn, or Co. Specific examples include Mn—Zn-based soft ferrites, Ni—Zn-based soft ferrites, and Cu—Zn-based soft ferrites. Examples of the metal-based soft magnetic materials include pure irons, Fe—X alloys (X: Ti, Mn, Ni, Co, Zr, Hf, V, Nb, Ta, Cr, Mo, W, Cu, Zn, Si), silicon steels (Fe—Si), Sendusts (Fe—Si—Al), Permendurs (Fe—Co), permalloys (Fe—Ni), electromagnetic stainless steels (Fe—Cr), and rapidly quenched ribbon powders (Fe—Si—B, Fe—Si—B—P—Cu). Examples of the pure irons include atomized iron, reduced iron, electrolytic iron, and carbonyl iron.

An Fe—X alloy contains a first phase containing Fe and X and a second phase containing X and having an X content that, when the sum of Fe and X in the second phase is taken as 100 atom %, is higher than the X content of the first phase when the sum of Fe and X in the first phase is taken as 100 atom %. The use of an Fe—X alloy as a soft magnetic material can further improve heat resistance. X is at least one selected from Ti, Mn, Ni, Co, Zr, Hf, V, Nb, Ta, Cr, Mo, W, Cu, Zn, and Si, and at least two of these may be selected. The first phase of the Fe—X alloy may have crystals with a bcc structure containing Fe and X. Preferably, except when X includes Co, both the first and second phases of the Fe—X alloy have crystals with a bcc structure containing Fe and X. This can improve magnetization. The crystallite size of the bcc phase in the first and/or second phase of the Fe—X alloy is preferably at least 1 nm but less than 100 nm. X can include Ni and/or Co and other additional components. In this case, the additional component content in the second phase is preferably higher than the additional component content in the first phase. The additional component contents in the first and second phases each refer to the additional component content (atom %) when the sum of X components including additional components and Fe in the corresponding first or second phase is taken as 100 atom %. This allows both low coercivity and improved magnetization to be achieved.

When the first and second phases have crystals with a bcc structure containing Fe and X components, the ratio of the X component content in the second phase to the X component content in the first phase, the second phase/first phase X component ratio, can be at least 1, and may be at least 1.1 but not more than 10⁵. The X component contents in the first and second phases each refer to the X component content (atom %) when the sum of Fe and X in the corresponding first or second phase is taken as 100 atom %. Such a second phase/first phase X component ratio allows both low coercivity and high magnetization to be achieved, and is thus suitable for a soft magnetic material with good high-frequency characteristics.

When the X components include Ti or Mn, the ratio of the Ti or Mn content in the second phase to the Ti or Mn content in the first phase, the second phase/first phase component ratio for Ti or Mn, is preferably at least 2 but not more than 10⁵. When the X components include one of Zr, Hf, V, Nb, Ta, Cr, Mo, W, Cu, Zn, and Si, the second phase/first phase component ratio for the corresponding component is preferably at least 1.5 but not more than 10⁵. When the X components include Ni or Co, the second phase/first phase component ratio for the corresponding component is preferably more than 1, more preferably at least 1.1 but not more than 10⁵. These second phase/first phase X component ratios make it possible to achieve both low coercivity and high magnetization and, for example, to obtain a soft magnetic material with a coercivity of not more than 10 Oe and a magnetization of at least 0.3 T. Such a soft magnetic material can be used to achieve lower losses in high-frequency applications. The Fe—X alloy can have a structure in which the nanoscale first and second phases are connected by ferromagnetic bonds due to the presence of nano-order X compositional fluctuations caused by disproportionation reactions during reduction. Such a structure probably leads to low coercivity and high magnetization. The Fe—X alloy can be obtained, for example, as described in WO 2017/164376 or WO 2018/155608.

The soft magnetic materials listed above may be used alone or in combinations of two or more. Among the soft magnetic materials, metal-based soft magnetic materials are preferred. This is because, when a metal-based soft magnetic material is used and coated as described later, it is easier to increase the electrical resistance of the magnetic material molded product and reduce losses, thus improving magnetization. Among the metal-based soft magnetic materials, pure irons or Fe—X alloys are preferred. In particular, Fe—X alloys with X being Mn (such alloys are referred to as “Fe—X (X═Mn)”), Fe—X alloys with X being Ni (such alloys are referred to as “Fe—X (X═Ni)”), or Fe—X alloys with X being Mn and Ni (such alloys are referred to as “Fe—X (X═Mn, Ni)”) are more preferred. These components listed as X may be X main components. When X═Mn, Ni, other components may be included in an amount smaller than the amount of Mn and Ni. More preferably, X consists substantially only of Mn and Ni. Fe—X (X═Mn) tends to have higher electrical resistance and heat resistance than Fe powder (pure iron) does. This is probably due to the inclusion of an X component-enriched phase. Fe—X (X═Ni) shows higher magnetization when the Ni content is higher than 0 but not higher than 12 atom %, as expected from the Slater-Pauling curve. Fe—X (X═Mn, Ni) can have the advantages of both Fe—X (X═Mn) and Fe—X (X═Ni). In other words, it is possible to increase electrical resistance and therefore reduce eddy current loss, and improve heat resistance and magnetization.

The magnetic material used is preferably in a powder form to facilitate the formation of a powder magnetic core of any shape. The particle size D50 of the magnetic powder can be, for example, at least 1 μm but not more than 5 mm, preferably at least 5 μm but not more than 1 mm, more preferably at least 10 μm but not more than 500 μm. In this range, coercivity can be reduced, and distortions during annealing can be reduced. Herein, the particle size D50 refers to the particle size corresponding to 50% of the cumulative particle size distribution by volume of the magnetic powder.

The coating procedure is preferably preceded by washing the magnetic material with an acidic aqueous solution to remove the impurities and oxide layer on the surface of the magnetic material. The acid compound used in the washing may be an inorganic or organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, and tartaric acid. The pH during the washing is preferably less than pH 7, more preferably less than pH 3. The washing time is preferably at least one minute but not more than 10 hours. During the washing, the aqueous solution is preferably stirred.

### Coating Procedure

In the coating procedure, an aqueous solution containing a phosphate compound and a rare earth compound is mixed with a magnetic material that is a soft magnetic material. As a result, the metal component in the magnetic material is reacted with the phosphate component in the phosphate compound to form a coating. The coating may be a coating containing a phosphorus compound containing a rare earth metal element or a coating containing a rare earth phosphate. Depending on the combination of elements in the coating and the atmosphere during heating after the coating formation, a coating containing a phosphorus compound other than phosphates may be obtained through heating after a coating containing a rare earth phosphate is formed.

Examples of the phosphate compound contained in the aqueous solution include orthophosphoric acid, sodium dihydrogen phosphate, sodium monohydrogen phosphate, ammonium dihydrogen phosphate, ammonium monohydrogen phosphate, zinc phosphate, calcium phosphate, and other phosphates, hypophosphorous acid and hypophosphites, pyrophosphoric acid, polyphosphoric acid, and other inorganic phosphoric acids, and organic phosphoric acids, and salts thereof. These may be used alone or in combinations of two or more.

The phosphate compound content, calculated as PO₄, in the aqueous solution is preferably at least 0.0001% by mass but not more than 50% by mass, more preferably at least 0.001% by mass but not more than 10% by mass. In such a range, the phosphate compound tends to have high solubility in water and high storage stability.

In the coating procedure, the rare earth metal element derived from the rare earth compound contained in the aqueous solution may adhere to the magnetic material. The rare earth compound content in the aqueous solution is preferably such that the rare earth metal element content is at least 0.0001% by mass, more preferably at least 0.01% by mass, still more preferably at least 0.1% by mass of the coated magnetic material. When the rare earth metal element content in the coated magnetic material is at least 0.0001% by mass, the coating amount of the coating tends to be stable. When the rare earth metal element content in the coated magnetic material is at least 0.01% by mass, losses tend to be further reduced. When the rare earth metal element content in the coated magnetic material is at least 0.1% by mass, the heat resistance tends to be further improved. The upper limit of the rare earth metal element content in the coated magnetic material may be not higher than 50% by mass, preferably not higher than 10% by mass. When the rare earth metal element content in the coated magnetic material is not higher than 50% by mass, the decrease in the magnetic permeability of the coated magnetic material can be reduced and the decrease in the characteristics can be reduced. The rare earth metal element may precipitate as a phosphorus compound containing the rare earth metal element or a phosphate containing the rare earth element on the surface of the magnetic material.

A rare earth metal element tends to have a small Gibbs energy change (ΔG) for the oxidation reaction in the temperature range (at least about 400° C. but not higher than about 700° C.) when the coated magnetic material is heated. Thus, the use of a rare earth compound in the coating procedure can result in a coated magnetic material with good heat resistance. The Gibbs energy changes for oxidation reactions at 600° C. of rare earth oxides are shown in Table 1.

TABLE 1

| Element | ΔG for oxidation at 600° C. [kJ/mol O₂] |
|---|---|
| Ce | −907.9 |
| La | −1028.5 |
| Nd | −1039.9 |
| Sm | −1046.5 |
| Dy | −1069.1 |

The rare earth compound contains a rare earth metal element. The rare earth metal element is preferably Ce, Nd, Sm, La, Dy, Y, or Pr, more preferably Ce, Nd, Sm, La, or Dy, still more preferably Ce, Sm, La, or Dy, particularly preferably Sm or Dy. The rare earth compound is preferably a compound that generates rare earth ions in an aqueous solution, such as a rare earth oxide, a rare earth hydroxide, a rare earth chloride, a rare earth sulfate, a rare earth nitrate, or a rare earth acetate, more preferably a rare earth chloride. Specific examples of preferred rare earth compounds include chlorides of at least one rare earth element selected from the group consisting of Ce, Nd, Sm, La, and Dy. These may be used alone or in combinations of two or more. Because rare earth chlorides tend to dissolve readily, the use of a rare earth chloride makes it easier to obtain the aqueous solution used in the coating procedure.

The rare earth compound content in the aqueous solution containing a phosphate compound and a rare earth compound is preferably at least 0.001% by mass but not higher than 10% by mass, more preferably at least 0.01% by mass but not higher than 5% by mass. In such a range, the rare earth compound tends to have high solubility in water and high storage stability.

The reaction time taken to form a coating on the surface of the magnetic material is preferably at least one minute but not more than 10 hours, more preferably at least five minutes but not more than two hours.

Examples of the reaction solvent used in the coating procedure include water and solvent mixtures of water and hydrophilic organic solvents. When these solvents are used, a smaller particle size phosphate may precipitate to form a denser coating than when hydrophobic organic solvents are used. Water is preferred among the solvents above. When a solvent mixture of water and a hydrophilic organic solvent is used, the hydrophilic organic solvent may be ethanol, methanol, 2-propanol, acetone, or 2-butanone. The hydrophilic organic solvent content in the solvent mixture is preferably at least 0.1% by mass but not higher than 80% by mass, more preferably at least 1% by mass but not higher than 50% by mass.

In the coating procedure, the pH of the aqueous solution may increase as more phosphate derived from the phosphate compound adheres to the magnetic material. In this case, the pH of the aqueous solution may be adjusted by adding an inorganic acid or an organic acid. When the pH is adjusted, the pH range can be higher than 0 but lower than 7, preferably at least 1 but not higher than 4.5, more preferably at least 1.6 but not higher than 3.9, still more preferably at least 2 but not higher than 3. When the pH is at least 1, the precipitation rate of the phosphorus compound containing a rare earth metal element can be reduced as compared to when the pH is lower than 1, and the thickness of the coating to be formed can be easily controlled. When the pH is at least 7, the amount of the precipitated phosphate tends to decrease, resulting in insufficient coating and increased losses. Thus, the pH is preferably lower than 7. When the pH is not higher than 4.5, the precipitation rate of the phosphate can be not too low. Examples of the inorganic acid include sulfuric acid, hydrochloric acid, nitric acid, phosphoric acid, boric acid, and hydrofluoric acid. Examples of the organic acid include acetic acid, formic acid, oxalic acid, and tartaric acid. Although an inorganic acid is preferably used in view of liquid waste disposal, an organic acid may be used together depending on the purpose. An inorganic acid and an organic acid may be used in admixture. When the pH is adjusted, the inorganic or organic acid may be added as needed to adjust the pH within the above-mentioned range during the coating procedure. In the coating procedure, as the pH initially increases rapidly, the inorganic or organic acid for pH control is preferably introduced at short intervals.

In the coating procedure, the magnetic material content in the mixture of the aqueous solution containing a phosphate compound and a rare earth compound with the magnetic material can be at least 0.0001% by mass but not higher than 70% by mass, preferably at least 0.01% by mass but not higher than 10% by mass. In such a range, the thickness of the coating tends to be stable.

To improve the water resistance and corrosion resistance of the coating and the magnetic properties of the magnetic powder, additives may also be added including, for example, oxoacid salts such as molybdates, tungstates, vanadates, and chromates; oxidizing agents such as sodium nitrate and sodium nitrite; and chelating agents such as EDTA. When the aqueous solution contains an oxoacid salt, the concentration thereof in the aqueous solution is preferably at least 0.0001% by mass but not higher than 10% by mass, more preferably at least 0.01% by mass but not higher than 1% by mass. When the aqueous solution contains an oxidizing agent, the concentration thereof in the aqueous solution is preferably at least 0.0001% by mass but not higher than 10% by mass, more preferably at least 0.01% by mass but not higher than 1% by mass. When the aqueous solution contains a chelating agent, the concentration thereof in the aqueous solution is preferably at least 0.0001% by mass but not higher than 10% by mass, more preferably at least 0.01% by mass but not higher than 1% by mass.

In the coating procedure, the components may be mixed in any order as long as an aqueous solution containing a phosphate compound and a rare earth compound can be ultimately mixed with a magnetic material that is a soft magnetic material. In the coating procedure, preferably, an aqueous solution containing the rare earth compound is firstly mixed with the magnetic material and then with the phosphate compound. Mixing an aqueous solution containing the rare earth compound with the magnetic material in advance allows the rare earth compound to easily adhere or bind to the surface of the magnetic material, making it possible to increase the amount of the coating containing a phosphorus compound. When the aqueous solution containing the rare earth compound is mixed with the magnetic material in advance, the mixture obtained by mixing them may be stirred preferably at a pH of at least 2 but not higher than 12, more preferably at a pH of at least 4 but not higher than 10, still more preferably at a pH of at least 5 but not higher than 8, preferably for at least one minute, more preferably at least five minutes, before adding an aqueous solution containing the phosphate compound.

In the method of producing a coated magnetic material according to the present embodiments, the coating procedure may be performed only once or may be performed at least twice. By performing the coating procedure at least twice, a thick coating containing a phosphorus compound containing a rare earth metal element can be formed on the surface of the magnetic material. The upper limit of the number of times the coating procedure is performed can be, for example, not more than 10, and may be not more than five. The number of times the coating procedure is performed may also be two.

When the coating procedure is performed at least twice, the magnetic material may be purified between the coating procedure and the next coating procedure. The magnetic material on which the coating is formed can be purified, for example, by heating at at least 100° C. but not higher than 800° C. or by filtration with a filter.

When the coating procedure is performed at least twice, the aqueous solution used in the n-th coating procedure is preferably obtained by adding the rare earth compound to the aqueous solution used in the (n−1)th coating procedure. In this case, the n-th coating procedure can be performed without purifying the magnetic material after the (n−1)th coating procedure. n is an integer of at least 2, but when the coating procedure is performed k times, n is preferably any integer of at least 2 but not more than k. When n is any integer of at least 2 but not more than k, an aqueous solution obtained by adding the rare earth compound to the aqueous solution used in the coating procedure is used in each of the second and subsequent coating procedures.

The type of the rare earth compound added to the aqueous solution used in the (n−1)th coating procedure may be the same as or different from the rare earth compound in the aqueous solution used in the n-th coating procedure.

The concentration of the rare earth compound added to the aqueous solution used in the (n−1)th coating procedure may be selected appropriately according to the reaction time of the n-th coating procedure and the type of rare earth compound. The concentration of the rare earth compound added to the aqueous solution used in the (n−1)th coating procedure is preferably at least 0.01 times but not more than 50 times, more preferably at least 0.1 times but not more than 10 times, the rare earth compound content in the aqueous solution used in the n-th coating procedure. In such a range, the thickness unevenness of the coating can be reduced.

When the coating procedure is performed at least twice, the pH of the mixture of the aqueous solution and the magnetic material obtained in the m-th coating procedure is preferably lower than the pH of the mixture of the aqueous solution and the magnetic material obtained in the (m−1)th coating procedure, and the difference therebetween is preferably at least 0.1, more preferably at least 1. Here, as the reaction between the phosphate compound and the magnetic material proceeds, the free phosphate content in the aqueous solution may decrease, and the pH of the mixture of the aqueous solution and the magnetic material may increase. If the pH fluctuates during the reaction, the pH of the mixture of the aqueous solution and the magnetic material obtained in the (m−1)th coating procedure refers to the pH at the end of the (m−1)th coating procedure. When the pH of the mixture of the aqueous solution and the magnetic material obtained in the m-th coating procedure is lower than that in the (m−1)th procedure, the efficiency of forming a coating containing a phosphorus compound on the magnetic material can be improved.

m is an integer of at least 2, but when the coating procedure is performed k times, m may be any integer of at least 2 but not more than k. When m is any integer of at least 2 but not more than k, an aqueous solution with a pH lower than the pH of the mixture of the aqueous solution and the magnetic material obtained in the previous coating procedure is used in each of the second and subsequent coating procedures. Alternatively, when k is at least 3, the pH in the first coating procedure may be different from the pH in the second coating procedure, and the pH in the third and subsequent coating procedures may be adjusted to be in the same pH range as in the second coating procedure.

In the m-th coating procedure, the pH of the aqueous solution may be adjusted by adding an inorganic acid or an organic acid. When the pH is adjusted, the pH range can be higher than 0 but lower than 7, preferably at least 1 but not higher than 4.5, more preferably at least 1.6 but not higher than 3.9, still more preferably at least 2 but not higher than 3. When the pH is at least 1, the precipitation rate of the phosphorus compound containing a rare earth metal element can be reduced as compared to when the pH is lower than 1, and the thickness of the coating to be formed can be easily controlled. When the pH is at least 7, the amount of the precipitated phosphate tends to decrease, resulting in insufficient coating and increased losses. Thus, the pH is preferably lower than 7. When the pH is not higher than 4.5, the precipitation rate of the phosphate can be not too low. The acid to be added may be an inorganic acid or an organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, and tartaric acid. Although an inorganic acid is preferably used in view of liquid waste disposal, an organic acid may be used together depending on the purpose. An inorganic acid and an organic acid may be used in admixture. When the pH is adjusted, the inorganic or organic acid may be added as needed to adjust the pH within the above-mentioned range during the coating procedure. In the coating procedure, as the pH initially increases rapidly, the inorganic or organic acid for pH control is preferably introduced at short intervals.

An inorganic acid or an organic acid may be added to the aqueous solution to adjust the pH within the range of at least 1 but not higher than 4.5 for at least one minute. To reduce the thin parts of the coating, this pH adjustment is preferably performed for at least 30 minutes. In the pH maintenance, as the pH initially increases rapidly, the inorganic or organic acid for pH control is preferably introduced at short intervals. Then, as the coating proceeds, pH fluctuations gradually decrease, which allows the inorganic or organic acid to be introduced at longer intervals. This allows one to determine the end point of the reaction.

The n-th coating procedure may also serve as the m-th coating procedure. In other words, the pH adjustment in the m-th coating procedure may be performed in the n-th coating procedure.

The coating procedure may be followed by coating with an aqueous solution containing a phosphate compound and a non-rare earth metal element compound. In this case, the method of producing a coated magnetic material preferably includes the above-described coating procedure as a primary coating procedure, followed by a secondary coating procedure including mixing an aqueous solution containing a phosphate compound and a non-rare earth metal element compound with the resulting magnetic material to form a coating containing phosphate and the non-rare earth metal element on the surface of the magnetic material. The amount of the coating containing phosphorus formed on the surface of the magnetic material can be increased by performing the secondary coating procedure. Performing the secondary coating procedure also allows the rare earth metal element to be localized on the side of the coating closer to the magnetic material.

The type and concentration of the phosphate compound in the aqueous solution used in the secondary coating procedure are as described above for the above coating procedure. The non-rare earth metal element may be one other than rare earth metal elements. Examples include metal elements other than rare earth metal elements, and semimetallic elements. Examples of the metal elements other than rare earth metal elements include alkali metal elements such as Li, Na, K, Rb, and Cs; alkaline earth metal elements such as Ca, Sr, Ba, and Mg; transition metal elements such as Ti, Zr, Hf, V, Nb, Ta, Cr, Mo, W, Mn, Fe, Ru, Co, Ni, Pd, Pt, Cu, Ag, and Au; Zn, Cd, and Al. Examples of the semimetallic elements include B, Al, Si, and Ge. Among these, metal elements are preferred. In order to obtain a coated magnetic material with good heat resistance, metal elements each of which have a Gibbs energy change (ΔG) for the oxidation reaction in the temperature range (at least about 400° C. but not higher than about 700° C.) when the coated magnetic material is heated that is −300 kJ/mol O₂ or less are more preferred. Transition metals are still more preferred, with Cr, W, Mn, Mo, Nb, and V being particularly preferred. Table 2 shows the Gibbs energy changes for oxidation reactions at 600° C. of oxides of metals other than rare earth elements.

TABLE 2

| Element | ΔG for oxidation at 600° C. [kJ/mol O₂] |
|---|---|
| Cu | −212.4 |
| Ni | −320.2 |
| W | −416.2 |
| Fe | −420.2 |
| Mo | −432.9 |
| K | −482.7 |
| Zn | −523.6 |
| Cr | −599.1 |
| Na | −596.4 |
| Mn | −641.8 |
| Ta | −666.0 |
| Nb | −675.2 |
| V | −709.6 |
| Si | −752.5 |
| Ti | −900.0 |
| Zr | −931.7 |
| Hf | −910.8 |
| Ba | −933.4 |
| Al | −934.8 |
| Mg | −1014.9 |
| Ca | −1086.9 |

The non-rare earth metal element compound in the aqueous solution is a different compound than the phosphate compound in the aqueous solution. Examples of the non-rare earth metal element compound include oxoacids, heteroacids, chlorides, hydroxides, nitrides, oxides, and borides of non-rare earth metal elements, with oxoacids being preferred. Oxoacids may be polyacids. Among these, metal oxoacid compounds are preferred, transition metal oxoacid compounds are more preferred, and Cr, W, Mn, Mo, Nb, and V oxoacid compounds are still more preferred. The compounds of non-rare earth metal elements listed above may be used alone or in combinations of two or more.

The non-rare earth metal element compound content in the aqueous solution used in the secondary coating procedure is preferably at least 0.001% by mass but not higher than 10% by mass, more preferably at least 0.01% by mass but not higher than 5% by mass.

In the secondary coating procedure, the reaction time taken to form a coating on the surface of the magnetic material is preferably at least one minute but not more than 10 hours, more preferably at least five minutes but not more than two hours.

In the secondary coating procedure, an inorganic acid or an organic acid is preferably added to the aqueous solution to adjust the pH. When the pH is adjusted, the pH range can be higher than 0 but lower than 7, preferably at least 1 but not higher than 4.5, more preferably at least 1.6 but not higher than 3.9, still more preferably at least 2 but not higher than 3. When the pH is at least 1, the precipitation rate of the phosphate can be reduced as compared to when the pH is lower than 1, and the thickness of the coating to be formed can be easily controlled. When the pH is at least 7, the amount of the precipitated phosphate tends to decrease, resulting in insufficient coating and increased losses. Thus, the pH is preferably lower than 7. When the pH is not higher than 4.5, the precipitation rate of the phosphate can be not too low. The acid to be added may be an inorganic acid or an organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, and tartaric acid. Although an inorganic acid is preferably used in view of liquid waste disposal, an organic acid may be used together depending on the purpose. An inorganic acid and an organic acid may be used in admixture. When the pH is adjusted, the inorganic or organic acid may be added as needed to adjust the pH within the above-mentioned range during the coating procedure. In the coating procedure, as the pH initially increases rapidly, the inorganic or organic acid for pH control is preferably introduced at short intervals.

An inorganic acid or an organic acid may be added to the aqueous solution to adjust the pH within the range of at least 1 but not higher than 4.5 for at least one minute. To reduce the thin parts of the coating, this pH adjustment is preferably performed for at least 30 minutes. In the pH maintenance, as the pH initially increases rapidly, the inorganic or organic acid for pH control is preferably introduced at short intervals. Then, as the coating proceeds, pH fluctuations gradually decrease, which allows the inorganic or organic acid to be introduced at longer intervals. This allows one to determine the end point of the reaction.

A purification procedure for the coated magnetic material may be performed after the coating procedure and optionally the secondary coating procedure described above. In the purification procedure for the coated magnetic material, the liquid component can be removed, for example, by heating at at least 100° C. but not higher than 500° C. or by filtration with a filter.

A coating fixation procedure may also be performed after the coating procedure and optionally the secondary coating procedure described above. In the coating fixation procedure, the purified coated magnetic material may be treated at a high temperature so that the phosphorus is baked onto the magnetic material. The temperature conditions of the high temperature treatment are preferably at least 50° C. but not higher than 500° C., more preferably at least 100° C. but not higher than 300° C. The high temperature treatment time is preferably at least one minute but not more than 100 hours, more preferably at least 10 minutes but not more than 10 hours.

### Method of Producing Molded Product

A method of producing a molded product according to the present embodiments includes obtaining a coated magnetic material and heating the coated magnetic material. The procedure of obtaining a coated magnetic material can be performed as described above for the method of producing a coated magnetic material.

In the heating procedure, the coated magnetic material is heated. The heating temperature is, for example, at least 100° C. but not higher than 1200° C. The heating procedure can be performed, for example, to release stress caused by pressurization and/or to partially react the coating of the coated magnetic material to obtain an integrated molded product. To release stress caused by pressurization, the heating temperature is preferably at least 300° C. but not higher than 1000° C., more preferably at least 400° C. but not higher than 700° C. As the coated magnetic material used in the present embodiments has a coating with good heat resistance, losses of the coating can be reduced even after the heating procedure. The heating temperature may be at least 500° C. In this case, the molded product preferably does not contain resin or glass. This is because resin and glass are likely to deteriorate significantly at a high temperature of at least 500° C. The duration of the heating procedure is preferably at least one minute but not more than 100 hours, more preferably at least 10 minutes but not more than 10 hours. The heating procedure may be carried out in a nitrogen atmosphere or in the air, for example. The heating procedure is preferably carried out in an inert atmosphere such as an argon atmosphere or vacuum. When the magnetic material contains Fe, the heating procedure is preferably carried out in an inert atmosphere other than a nitrogen atmosphere because heating in a nitrogen atmosphere may nitride the magnetic material and degrade the characteristics of the magnetic material.

The heating procedure is preferably preceded by pressurizing the coated magnetic material to obtain a pressure molded product. In this case, the heating procedure corresponds to heating the pressure molded product obtained in the procedure of obtaining a pressure molded product.

The pressurization conditions are preferably at least 0.01 GPa but not higher than 10 GPa, more preferably at least 0.5 GPa but not higher than 5 GPa. The coated magnetic material may be disposed into a mold and then pressurized to obtain a pressure molded product of the desired shape. When a mold is used, a lubricant, which will be described later, may be applied to the inner walls of the mold cavity before disposing the coated magnetic material. Applying a lubricant to the inner walls of the mold cavity can improve the releasability of the pressure molded product from the mold.

In the pressurization, the coated magnetic material may be pressurized alone. In the pressurization, the coated magnetic material may be mixed with a binder, a lubricant, etc. before being pressurized. Examples of the binder include thermosetting resins such as epoxy resins, urethane resins, phenolic resins, methacrylic resins, acrylic resins, and silicone resins, and thermoplastic resins such as polyamide resins. The amount of the binder used per 100 parts by mass of the coated magnetic material is preferably at least 0.01 parts by mass but not more than 1000 parts by mass, more preferably at least one part by mass but not more than 50 parts by mass. When the amount of the binder used is within the above range, a molded product with good mechanical strength and low losses such as low iron loss can be obtained.

Examples of the lubricant include metallic soaps such as zinc stearate, calcium stearate, and lithium stearate, amines or amides such as 1,2-bis(stearoylamino)ethane, long chain hydrocarbons such as waxes, and silicone oils. The amount of the lubricant used per 100 parts by mass of the coated magnetic material is preferably at least 0.00001 parts by mass but not more than 10 parts by mass, more preferably at least 0.01 parts by mass but not more than five parts by mass. When the amount of the lubricant used is within the above range, the releasability of the pressure molded product from the mold cavity can be improved.

The filling ratio of the molded product obtained in the present embodiments can be at least 10% but not higher than 100%, preferably at least 80% but not higher than 100%. The filling ratio here refers to the ratio (percentage) of the molded product density to the true density. The ratio (percentage) of the volume of the coated magnetic material to the volume of the molded product obtained in the present embodiments may be at least 40% but not higher than 100%, preferably at least 80% but not higher than 100%. The ratio of the area of the coated magnetic material to the area of the molded product in a cross section of a portion of the molded product may be regarded as the ratio of the volume of the coated magnetic material to the volume of the molded product.

Because the molded product obtained in the present embodiments is an aggregate of the coated magnetic material having a coating with good heat resistance, the coating is maintained after the heating procedure, and losses such as iron loss can be reduced. After the heating procedure, the coatings of the individual coated magnetic material particles may partially react to fuse and integrate with the coatings of the adjacent coated magnetic material particles while maintaining the insulation between the magnetic material particles. The molded product according to the present embodiments can be obtained from the coated magnetic material without the use of a binder such as a resin or glass. Resins may give rise to eddy currents when carbonized by heat treatment. Glass may also be deteriorated by heat treatment. For this reason, when a binder such as a resin or glass is used, the temperature of the heat treatment, if performed, is preferably relatively low. In the case of a molded product containing no resin or glass, even when heated at a relatively high temperature such as 500° C. or higher, it is possible to reduce the increase in losses. Moreover, heating at a relatively high temperature can more effectively release stress caused by pressurization. Moreover, the combined use with the lubricant described above can increase the molded product density and allow the adjacent coated magnetic material particles to be bonded through a chemical reaction, thereby improving mechanical strength.

### Coated Magnetic Material

A coated magnetic material according to the present embodiments includes a magnetic material that is a soft magnetic material, and a coating containing a rare earth metal element, phosphorus, and oxygen provided on a surface of the magnetic material. The coating can contain a phosphorus compound containing a rare earth metal element, and the phosphorus compound may be a phosphate. The coating may contain an oxide containing no rare earth metal element. In this case, the phosphorus compound containing a rare earth metal element may not be a phosphate. Examples of the rare earth metal element include Ce, Nd, Sm, La, Dy, Y, and Pr, with Ce, Nd, Sm, La, and Dy being preferred. Although the coated magnetic material according to the present embodiments can be obtained, for example, by the method of producing a coated magnetic material described above, it may also be obtained by any other production method.

The particle size D50 of the coated magnetic powder is, for example, at least 1 μm but not more than 5 mm, preferably at least 5 μm but not more than 1 mm, more preferably at least 10 μm but not more than 500 μm. In such a range, coercivity can be reduced, and distortions during annealing can be reduced. Herein, the particle size D50 refers to the particle size corresponding to 50% of the cumulative particle size distribution by volume of the coated magnetic powder.

The thickness of the coating containing a rare earth metal element, phosphorus, and oxygen is preferably at least 2 nm but not more than 10 μm, more preferably at least 5 nm but not more than 500 nm, in terms of the insulating properties and heat resistance of the coated magnetic material. The thickness of the coating can be measured by compositional analysis using an energy dispersive X-ray analysis (EDX) line scan of a cross section of the coated magnetic material.

Preferably, oxygen is present in a larger amount than phosphorus in the coating. In this case, there is at least some region where oxygen is present in a larger amount than phosphorus in the thickness direction of the coating. The region where oxygen is present in a larger amount than phosphorus preferably accounts for at least 10%, more preferably at least 50%, still more preferably the entire region, in the thickness direction of the coating. The oxygen content is preferably more than 1 times the phosphorus content, and can be at least two times, or may be at least three times, the phosphorus content. The upper limit of the oxygen content can be, for example, not more than 10 times the phosphorus content.

The coating may contain, in addition to the rare earth metal element, phosphorus, and oxygen, a non-rare earth metal element other than phosphorus and oxygen. Examples of the non-rare earth metal element other than phosphorus and oxygen include metal elements other than rare earth metal elements, semimetallic elements, H, C, N, O, F, P, S, Cl, Br, and I. Examples of the metal elements other than rare earth metal elements include alkali metal elements such as Li, Na, K, Rb, and Cs; alkaline earth metal elements such as Ca, Sr, and Ba; transition metal elements such as Fe, Ti, Zr, Hf, V, Nb, Ta, Cr, Mo, W, Mn, Ru, Co, Ni, Pd, Pt, Cu, Ag, and Au; Zn, Cd, and Al. Examples of the semimetallic elements include B, Al, Si, and Ge. Among these, metal elements are preferred. In order to obtain a coated magnetic material with good heat resistance, metal elements each of which have a Gibbs energy change (ΔG) for the oxidation reaction in the temperature range (at least about 400° C. but not higher than about 700° C.) when the coated magnetic material is heated that is −300 kJ/mol O₂ or less are more preferred. Transition metals are still more preferred, with Cr, W, Mn, Mo, Nb, and V being particularly preferred. These elements, when present in the coating, may be derived from the magnetic material to be coated, or may be elements that were present during the coating formation reaction.

When the coating contains a non-rare earth metal element other than phosphorus and oxygen, the non-rare earth metal element and the rare earth metal element are preferably present in the coating such that, in the direction from the surface of the coating toward the magnetic material, the non-rare earth metal element shows the maximum amount, and then the rare earth metal element shows the maximum amount. In this case, the insulating properties tend to improve. When the thickness of the coating is T, the distance between the position with the maximum amount of the non-rare earth metal element and the position with the maximum amount of the rare earth metal element in the direction from the surface of the coating toward the magnetic material is preferably at least 0.001×T but not more than 0.99×T, more preferably at least 0.1×T but not more than 0.9×T. The insulating properties tend to further improve in the range of at least 0.1×T but not more than 0.9×T.

Preferably, after the non-rare earth metal element shows the maximum amount, its amount decreases and then turns into an increase in the direction from the surface of the coating toward the magnetic material. With such a distribution, the heat resistance of the coating tends to improve. A coating can be formed such that the amount of the non-rare earth metal element has such a distribution by performing the coating procedure at least twice and adding an inorganic acid to the aqueous solution used in the second or subsequent coating procedure to adjust the pH to at least 1 but not higher than 4.5. The minimum amount of the non-rare earth metal element decreasing after showing the maximum amount but before turning into an increase is preferably not more than 0.9 times, more preferably not more than 0.5 times, the maximum amount. The lower limit of the minimum amount can be at least 0.001 times the maximum amount.

In the coating, each of the above elements may be present in either the crystalline form or the amorphous form. Moreover, the concentration (atom %) of each element in the coating can be measured by compositional analysis using an EDX line scan of the coated magnetic material. The presence of a phosphate compound or composite oxide in microcrystalline form in the coating can increase mechanical strength and improve heat resistance.

The soft magnetic material included in the coated magnetic material according to the present embodiments can be as described above for the method of producing a coated magnetic material. Examples include oxide-based soft magnetic materials and metal-based soft magnetic materials. Examples of the oxide-based soft magnetic materials include materials containing an iron oxide and a transition metal such as Ni, Zn, Cu, Mn, or Co. Specific examples include Mn—Zn-based soft ferrites, Ni—Zn-based soft ferrites, and Cu—Zn-based soft ferrites. Examples of the metal-based soft magnetic materials include pure irons, Fe—X alloys (X: Ti, Mn, Ni, Co, Zr, Hf, V, Nb, Ta, Cr, Mo, W, Cu, Zn, Si), silicon steels (Fe—Si), Sendusts (Fe—Si—Al), Permendurs (Fe—Co), permalloys (Fe—Ni), electromagnetic stainless steels (Fe—Cr), and rapidly quenched ribbon powders (Fe—Si—B, Fe—Si—B—P—Cu). Examples of the pure irons include atomized iron, reduced iron, electrolytic iron, and carbonyl iron. An Fe—X alloy can be provided by reducing a ferrite powder, which mainly contains an X component not easily reduced by hydrogen, in a reducing gas containing hydrogen gas, followed by a disproportionation reaction to form a first phase and a second phase. The alloy thus has a large surface area with fine compositional fluctuations on the surface. Due to this special microstructure, the alloy is presumed to easily form a dense phosphate coating or passive layer with the phosphorus compound containing a rare earth metal element or the non-rare earth metal element such as Cr, W, Mn, Mo, Nb, or V. Fe—X alloys, compared to pure irons, for example, tend to provide reductions not only in hysteresis loss but also in eddy current loss and provide a great improvement in iron loss.

The rare earth metal element content in the coated magnetic material is preferably at least 0.0001% by mass, more preferably at least 0.01% by mass, still more preferably at least 0.1% by mass. When the rare earth metal element content is at least 0.0001% by mass, the coated magnetic material tends to be resistant to heat treatment at high temperatures. When the rare earth metal element content is at least 0.01% by mass, the coated magnetic material tends to be resistant to heat treatment at higher temperatures. When the rare earth metal element content is at least 0.1% by mass, a coated magnetic material with further improved insulating properties tends to be obtained. The upper limit of the rare earth metal element content can be not more than 50% by mass, preferably not more than 10% by mass. When the rare earth metal element content in the coated magnetic material is not more than 50% by mass, the decrease in the magnetic permeability of the coated magnetic material can be reduced, and the decrease in the characteristics can be reduced. The rare earth metal element content in the coated magnetic material can be measured by ICP atomic emission spectroscopy (ICP-AES).

The phosphorus content in the coated magnetic material is preferably at least 0.0001% by mass but not higher than 15% by mass, more preferably at least 0.001% by mass but not higher than 5% by mass. In the above range, the heat resistance tends to improve. The phosphorus content in the coated magnetic material can be measured by ICP atomic emission spectroscopy (ICP-AES).

The iron loss W of the molded product containing the coated magnetic material can be not more than 150 W/kg, preferably not more than 100 W/kg, more preferably not more than 80 W/kg. The lower limit of the iron loss W may be at least 4 W/kg. The hysteresis loss Wₕ of the coated magnetic material can be not more than 70 W/kg, preferably not more than 60 W/kg, more preferably not more than 45 W/kg. The lower limit of the hysteresis loss Wₕ may be at least 3.9 W/kg. The eddy current loss Wₑ of the coated magnetic material can be not more than 90 W/kg, preferably not more than 40 W/kg, more preferably not more than 35 W/kg. The lower limit of the eddy current loss Wₑ may be at least 0.1 W/kg. Here, these losses are measured at a maximum flux density (Bmax) of 1 T and a frequency of 400 Hz as described in EXAMPLES. The present embodiments can provide such numerical ranges to the molded product that has undergone the heating procedure. The heating temperature in the heating procedure can be 600° C., for example. The molded product with iron loss W and other losses within these numerical ranges may contain no resin and no glass. When the coated magnetic material, not the molded product, has undergone the heating procedure, the iron loss W, hysteresis loss Wₕ, and eddy current loss Wₑ of the coated magnetic material measured may be in the ranges described above.

### Molded Product

A molded product according to the present embodiments contains the above-described coated magnetic material. The molded product can be obtained by the method of producing a molded product described above. The molded product can be used as a powder magnetic core with lower iron loss in various applications. The molded product can be applied, for example, to transformers, coils, heads, inductors, reactors, cores (magnetic cores), yokes, various actuators, etc. The molded product can also be used as a soft magnetic component incorporated into any of various motors, such as motors for rotating machines and linear motors. Examples of the motors for rotating machines include voice coil motors, induction motors, and reluctance motors.

### EXAMPLES

Examples are described below. It should be noted that “%” is by mass unless otherwise specified.

### (1) Evaluation Method

### (1-1) Iron Loss

A coated magnetic material was disposed into a mold having an inner diameter of 10 mm and an outer diameter of 14 mm. In the examples except for Example 16, the coated magnetic material was molded at an increased pressure of 1 GPa and then heated in an Ar atmosphere at 600° C. for one hour to provide a toroidal molded product. In Example 16, 0.2% by mass of lubricants (1,2-bis(stearoylamino)ethane, zinc stearate) was added to a magnetic powder, and the mixture was disposed into the same mold and molded at 200° C. under an increased pressure of 1.5 GPa, followed by heat treatment at 520° C. in the atmosphere and then at 600° C. in an Ar atmosphere for one hour to provide a toroidal molded product. These molded products were wound with a copper wire by 50 turns on the primary side and 50 turns on the secondary side to provide evaluation samples. These evaluation samples were evaluated for W10/400 (iron loss at 400 Hz and 1 T) using a B—H analyzer (SY-8218, available from Iwatsu Electric Co., Ltd.). At the same time, the iron loss was measured from 10 Hz to 1 kHz at a flux density of 1 T and fit to a second-order polynomial to determine the hysteresis loss Wₕ10/400 and eddy current loss Wₑ10/400 at 400 Hz and 1 T.

### (1-2) Coating Thickness and Atomic Concentration

The coating thicknesses and atomic concentrations of the coated magnetic material were measured as follows. First, the resulting coated magnetic material was molded into a φ10-mm disk and heated in an Ar atmosphere at 600° C. for one hour to provide a molded product. The molded product was embedded in EpoxiCure resin and then processed by ion milling, from which a sample was taken out by a microsampling method and then sectioned by focused ion beam (FIB). The respective values of the resulting sample were estimated using a scanning transmission electron microscope (STEM; available from JEOL; acceleration voltage 200 kV) and an energy dispersive X-ray analyzer (EDX; available from JEOL). To determine the atomic concentrations in the coating, a line scan was performed in steps of 0.791 nm from the exterior to the interior of the coated magnetic material to observe continuous changes in the atomic concentrations of the constituent elements, thereby determining a region where the atomic concentration of phosphorus (P) was at least 1 atom %. Here, because a lot of the carbon (C) in the resin used to provide the cross-section sample might be detected in some measurement points, the atomic concentrations were calculated based on the sum of those of the elements excluding C.

### (2) Examples 1 to 15, Comparative Examples 1 to 13

### (2-1) Production of Coated Magnetic Material

### (i-i) Provision of Soft Magnetic Material: Example 1, Comparative Examples 1 and 3

A commercially available water-atomized iron powder was provided as a soft magnetic material (magnetic material) in Example 1 and Comparative Examples 1 and 3.

### (i-ii) Provision of Soft Magnetic Material: Comparative Example 2

A commercially available water-atomized iron powder (coated with iron phosphate) was provided as a soft magnetic material (magnetic material) in Comparative Example 2.

### (i-iii) Provision of Soft Magnetic Material: Examples 2 to 15, Comparative Examples 4 to 13

Fe—X alloys were provided as soft magnetic materials (magnetic materials) in Examples 2 to 15 and Comparative Examples 4 to 13. The Fe—X alloys were produced as follows. First, an aqueous solution was provided from MnCl₂·4H₂O (manganese(II) chloride tetrahydrate), NiCl₂·6H₂O (nickel(II) chloride hexahydrate), and FeCl₂·4H₂O (iron(II) chloride tetrahydrate) as raw materials. The aqueous solution and potassium hydroxide as a pH adjuster were used to provide a Mn—Ni-ferrite. The ferrite was heated at 12° C./min to 950° C. and then at 2° C./min to 1050° C., followed by reduction treatment at 1050° C. for one hour in a hydrogen atmosphere. The reduced ferrite was then quenched to room temperature and slowly oxidized in an argon atmosphere at an oxygen partial pressure of 3% by volume for 30 minutes to provide a soft magnetic material. The D50 of the Fe—Ni—Mn powder was 250 μm. The composition of the Fe—X alloys in Examples 2 to 8 and Comparative Examples 4 to 13 was Fe₉₆Ni_{3.9}Mn_{0.1}, and the composition of the Fe—X alloys in Examples 9 to 15 was Fe_{95.5}Ni_{4.4}Mn_{0.1}.

### (i-iv) Provision of Soft Magnetic Material: Example 16

A Fe—X alloy was produced as a soft magnetic material in Example 16 by the same procedure as in Examples 2 to 8 and Comparative Examples 4 to 13, except that the raw materials were MnSO₄·5H₂O (manganese(II) sulfate pentahydrate), NiSO₄·6H₂O (nickel(II) sulfate hexahydrate), and FeSO₄·7H₂O (iron(II) sulfate heptahydrate), and the pH adjuster was NaOH.

### (ii) Washing of Soft Magnetic Material

The soft magnetic material listed in Table 3 in an amount of 10 g was added to an aqueous solution adjusted to pH 1.1 or lower with dilute hydrochloric acid, followed by stirring for ten minutes to remove the oxidized surface layer and contaminants.

(iii) Primary Coating Procedure

An aqueous solution containing 10% by mass of the rare earth compound or non-rare earth compound listed in Table 3 relative to the amount of the soft magnetic material was added to the washed soft magnetic material, and the mixture was stirred for 15 minutes. Subsequently, an aqueous phosphate solution at pH 2 containing 40% by mass of the phosphate compound listed in Table 3 relative to the amount of the soft magnetic material was added, followed by stirring for seven minutes. The final concentration of each component was as follows: 1.6% by mass of the soft magnetic material, 0.16% by mass of the rare earth compound or non-rare earth compound, and 0.4% by mass of the phosphate compound (calculated as PO₄). The pH of the treatment tank rose from 3 to 5.

In Example 3, Comparative Example 3, and Comparative Example 5, only the aqueous phosphate solution was added without addition of the aqueous solution containing the rare earth compound or non-rare earth compound.

### (iv) Secondary Coating Procedure

An aqueous solution containing 10% by mass of the rare earth compound listed in Table 3 relative to the amount of the soft magnetic material was added, and the reaction mixture was stirred for 30 minutes while the pH of the reaction mixture was controlled within the range of 2.5±0.1 by introducing 6% by mass of hydrochloric acid as needed.

### (v) Drying and Baking

The soft magnetic material after the secondary coating procedure was dried by heating at 100° C. for four hours under vacuum conditions. The coating was then baked by heating at 200° C. for four hours.

### (2-2) Production of Molded Product

The coated magnetic materials thus provided were used to produce molded products for iron loss evaluation as described above for the evaluation method for iron loss. Moreover, the coated magnetic materials of Examples 10 and 16 were used to produce molded products for coating evaluation as described above for the evaluation methods for coating thickness and atomic concentrations.

The iron loss (hysteresis loss and eddy current loss) was measured on the resulting molded products for iron loss evaluation. Table 3 shows the results.

TABLE 3

| | | | | | | | Iron loss | | |
|---|---|---|---|---|---|---|---|---|---|
| | | | Sec- | | | | (Bmax = 1 T, | | |
| | | Primary | ondary | | | | frequency 400 Hz) | | |
| | Soft | coating | coating | | | | W | Wh | We |
| | magnetic | proce- | proce- | | Rare | Non-rare | (W/ | (W/ | (W/ |
| | material | dure | dure | Phosphate compound | earth compound | earth compound | kg) | kg) | kg) |
| Ex. 1 | Commercial | YES | YES | Orthophosphoric acid, | Samarium chloride | Sodium molybdate | 91.4 | 52.6 | 38.8 |
| | iron powder | | | sodium dihydrogen phosphate | (SmCl₃) | (Na₂MoO₄•2H₂O) | | | |
| Ex. 2 | Fe—X | YES | NO | Orthophosphoric acid, | Samarium chloride | — | 85.0 | 51.5 | 33.5 |
| | | | | sodium dihydrogen phosphate | (SmCl₃) | | | | |
| Ex. 3 | Fe—X | NO | YES | Orthophosphoric acid, | Samarium chloride | — | 78.7 | 47.9 | 30.9 |
| | | | | sodium dihydrogen phosphate | (SmCl₃) | | | | |
| Ex. 4 | Fe—X | YES | YES | Orthophosphoric acid, | Neodymium chloride | — | 79.2 | 44.8 | 34.3 |
| | | | | sodium dihydrogen phosphate | (NdCl₃) | | | | |
| Ex. 5 | Fe—X | YES | YES | Orthophosphoric acid, | Cerium chloride | — | 73.6 | 48.7 | 24.9 |
| | | | | sodium dihydrogen phosphate | (CeCl₃) | | | | |
| Ex. 6 | Fe—X | YES | YES | Orthophosphoric acid, | Lanthanum chloride | — | 69.7 | 51.9 | 17.8 |
| | | | | sodium dihydrogen phosphate | (LaCl₃) | | | | |
| Ex. 7 | Fe—X | YES | YES | Orthophosphoric acid, | Dysprosium chloride | — | 61.9 | 46.3 | 15.6 |
| | | | | sodium dihydrogen phosphate | (DyCl₃) | | | | |
| Ex. 8 | Fe—X | YES | YES | Orthophosphoric acid, | Samarium chloride | — | 64.7 | 49.3 | 15.5 |
| | | | | sodium dihydrogen phosphate | (SmCl₃) | | | | |
| Ex. 9 | Fe—X | YES | YES | Orthophosphoric acid, | Samarium chloride | Sodium tungstate | 42.8 | 35.0 | 7.7 |
| | | | | sodium dihydrogen phosphate | (SmCl₃) | (Na₂WO₄) | | | |
| Ex. 10 | Fe—X | YES | YES | Orthophosphoric acid, | Samarium chloride | Sodium molybdate | 47.9 | 41.7 | 6.1 |
| | | | | sodium dihydrogen phosphate | (SmCl₃) | (Na₂MoO₄•2H₂O) | | | |
| Ex. 11 | Fe—X | YES | YES | Orthophosphoric acid, | Samarium chloride | Sodium chromate | 34.0 | 29.0 | 5.0 |
| | | | | sodium dihydrogen phosphate | (SmCl₃) | (Na₂CrO₄) | | | |
| Ex. 12 | Fe—X | YES | YES | Orthophosphoric acid, | Samarium chloride | Potassium dichromate | 36.2 | 29.5 | 6.7 |
| | | | | sodium dihydrogen phosphate | (SmCl₃) | (K₂Cr₂O₇) | | | |
| Ex. 13 | Fe—X | YES | YES | Orthophosphoric acid, | Samarium chloride | Sodium metavanadate | 30.4 | 27.5 | 2.9 |
| | | | | sodium dihydrogen phosphate | (SmCl₃) | (NaVO₃) | | | |
| Ex. 14 | Fe—X | YES | YES | Orthophosphoric acid, | Samarium chloride | Sodium niobate | 45.2 | 31.8 | 13.4 |
| | | | | sodium dihydrogen phosphate | (SmCl₃) | (NaNbO₃) | | | |
| Ex. 15 | Fe—X | YES | YES | Orthophosphoric acid, | Samarium chloride | Potassium permanganate | 41.3 | 30.8 | 10.5 |
| | | | | sodium dihydrogen phosphate | (SmCl₃) | (KMnO₄) | | | |
| Ex. 16 | Fe—X | YES | YES | Orthophosphoric acid, | Samarium chloride | Sodium molybdate | 38.6 | 32.4 | 6.2 |
| | | | | sodium dihydrogen phosphate | (SmCl₃) | (Na₂MoO₄•2H₂O) | | | |
| Comp. | Commercial | NO | NO | — | — | — | 328.7 | 185.6 | 143.1 |
| Ex. 1 | iron powder | | | | | | | | |
| Comp. | Commercial | NO | NO | — | — | — | 238.3 | 98.2 | 140.1 |
| Ex. 2 | iron powder | | | | | | | | |
| | (coated with | | | | | | | | |
| | phosphate) | | | | | | | | |
| Comp. | Commercial | NO | NO | Orthophosphoric acid, | — | — | 209.6 | 84.1 | 125.5 |
| Ex. 3 | iron powder | | | sodium dihydrogen phosphate | | | | | |
| Comp. | Fe—X | NO | NO | — | — | — | 105.0 | 54.5 | 50.5 |
| Ex. 4 | | | | | | | | | |
| Comp. | Fe—X | NO | NO | Orthophosphoric acid, | — | — | 82.8 | 48.0 | 34.7 |
| Ex. 5 | | | | sodium dihydrogen phosphate | | | | | |
| Comp. | Fe—X | YES | YES | Orthophosphoric acid, | — | Copper chloride | 317.9 | 132.6 | 185.4 |
| Ex. 6 | | | | sodium dihydrogen phosphate | | (CuCl₂) | | | |
| Comp. | Fe—X | YES | YES | Orthophosphoric acid, | — | Phosphotungstic acid hydrate | 95.5 | 47.9 | 47.6 |
| Ex. 7 | | | | sodium dihydrogen phosphate | | (P₂O₅•24WO₃•xH₂O) | | | |
| Comp. | Fe—X | YES | YES | Orthophosphoric acid, | — | Zinc chloride | 99.6 | 55.6 | 43.9 |
| Ex. 8 | | | | sodium dihydrogen phosphate | | (ZnCl₂) | | | |
| Comp. | Fe—X | YES | YES | Orthophosphoric acid, | — | Iron chloride | 91.1 | 47.7 | 43.4 |
| Ex. 9 | | | | sodium dihydrogen phosphate | | (FeCl₂) | | | |
| Comp. | Fe—X | YES | YES | Orthophosphoric acid, | — | Hafnium chloride | 93.9 | 53.7 | 40.2 |
| Ex. 10 | | | | sodium dihydrogen phosphate | | (HfCl₄) | | | |
| Comp. | Fe—X | YES | YES | Orthophosphoric acid, | — | Titanium chloride | 85.9 | 48.8 | 37.0 |
| Ex. 11 | | | | sodium dihydrogen phosphate | | (TiCl₄) | | | |
| Comp. | Fe—X | YES | YES | Orthophosphoric acid, | — | Zirconium chloride | 96.6 | 59.8 | 36.8 |
| Ex. 12 | | | | sodium dihydrogen phosphate | | (ZrCl₄) | | | |
| Comp. | Fe—X | YES | YES | Orthophosphoric acid, | — | Nickel chloride | 83.9 | 47.8 | 36.1 |
| Ex. 13 | | | | sodium dihydrogen phosphate | | (NiCl₂) | | | |

### Ex: Example

### Comp. Ex.: Comparative Example

In Table 3, the columns for the primary and secondary coating procedures are marked with “YES” for the test examples in which these procedures were performed and “NO” for the test examples in which these procedures were not performed. Comparative Example 1 (no phosphate treatment), Comparative Example 2 (commercially available phosphorus-coated magnetic material), and Comparative Example 3 (no rare earth compound) showed high iron loss. Example 1 in which the same soft magnetic material was used showed lower iron loss.

Compared to Comparative Example 4 (no phosphate treatment), Comparative Example 5 (no rare earth compound), and Comparative Examples 6 to 13, Examples 2 to 15 in which the same soft magnetic material was used showed lower iron loss. In particular, Examples 9 to 15 in which the coating procedure using a non-rare earth compound was performed showed significantly reduced iron loss.

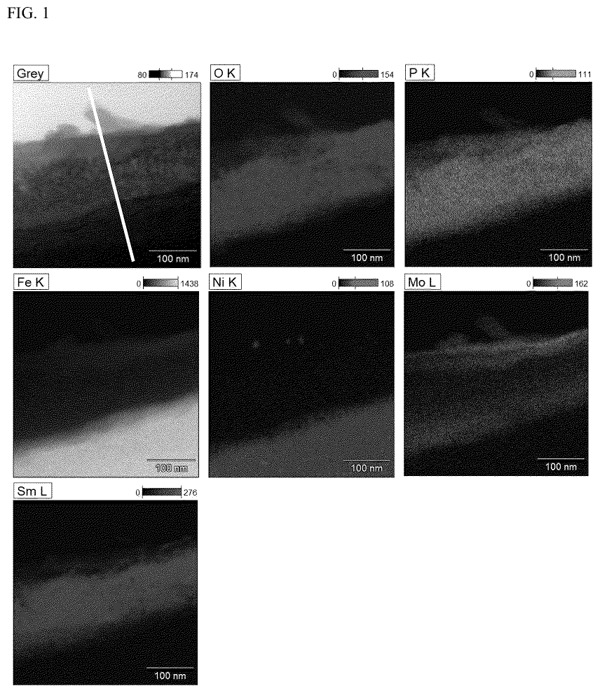

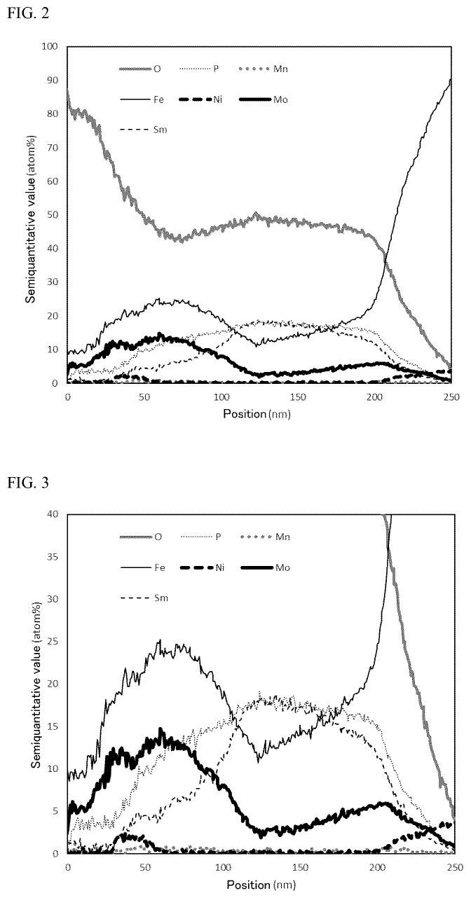

The vicinity of the surface of the molded product for coating evaluation with the coated magnetic material of Example 10 was observed using STEM-EDX. The obtained STEM image is shown in FIG. 1. FIG. 1 includes elemental mapping (EDS) images of O, P, Fe, Ni, Mo, and Sm. The line scan results of metal elements, P, and O on the white line in the image labelled as “Grey” in FIG. 1 are shown in FIGS. 2 and 3. FIG. 3 is an enlarged view of the region from 0 to 40 atom % in FIG. 2.

In FIGS. 1 to 3, the thickness of the coating on the surface of the magnetic material was about 200 nm. In FIG. 3, O was present in a larger amount than P throughout the coating. In the direction from the surface of the coating toward the magnetic material, the maximum amounts of Mo and Fe were observed, and then the maximum amount of Sm was observed. Mo is probably derived from the sodium molybdate added in the coating procedure, and Fe is probably derived from the magnetic material.

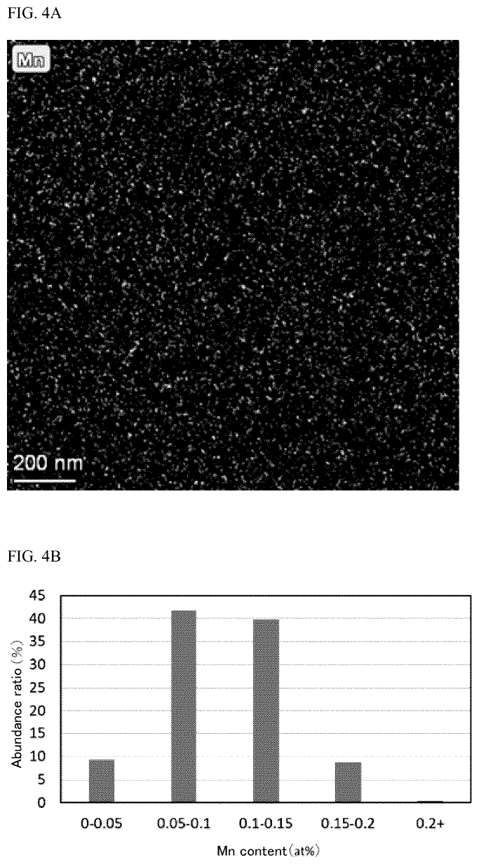

A portion of a cross section of the molded product for coating evaluation with the coated magnetic material of Example 16 was observed using STEM-EDX. FIGS. 4A and 4B show the results. FIG. 4A is a Mn distribution chart measured by STEM-EDX analysis using characteristic X-rays. The black colored areas indicate low Mn contents and the white colored areas indicate high Mn contents. In this EDX analysis, the screen was divided into 512×512 pixels of 3 nm square, and the characteristic X-ray dose at the center of each pixel was measured by focusing the electron beam diameter to 1 nm.

FIG. 4B is a histogram showing the distribution of Mn content. In FIG. 4B, the distribution of Mn content is shown by dividing the Mn contents at all measurement points into the following five classes: at least 0 atom % but less than 0.05 atom % (indicated as 0-0.05 on the horizontal axis in FIG. 4B); at least 0.05 atom % but less than 0.1 atom % (indicated as 0.05-0.1 on the horizontal axis in FIG. 4B); at least 0.1 atom % but less than 0.15 atom % (indicated as 0.1-0.15 on the horizontal axis in FIG. 4B); at least 0.15 atom % but less than 0.2 atom % (indicated as 0.15-0.2 on the horizontal axis in FIG. 4B); and at least 0.2 atom % (indicated as 0.2+ on the horizontal axis in FIG. 4B), and expressing the number of pixels of each concentration class as a percentage (referred to as abundance ratio). FIG. 4B shows that the abundance ratio of pixels having a Mn concentration of at least 0 atom % but less than 0.05 atom %, which correspond to a first phase, is about 10% of the total pixels. The abundance ratio of pixels having a Mn content of at least 0.1 atom % is about 50% of the total pixels and is thus considered to be the abundance ratio of a second phase having a Mn content higher than the Mn content of the first phase. FIG. 4A and FIG. 4B show that the Fe—X alloy as a soft magnetic material used in the coated magnetic material of Example 16 was phase-separated into the first phase and the second phase.

What is claimed is:

1. A method of producing a coated magnetic material, comprising:
a coating procedure comprising mixing a soft magnetic material and an aqueous solution containing a phosphate compound and a rare earth compound to form a first coating containing a phosphorus compound containing a rare earth metal element on a surface of the soft magnetic material.

2. The method of producing a coated magnetic material according to claim 1,
wherein the rare earth compound comprises at least one chloride containing at least one selected from the group consisting of Ce, Nd, Sm, La, and Dy.

3. The method of producing a coated magnetic material according to claim 1,
wherein in the coating procedure, an aqueous solution containing the rare earth compound is mixed with the soft magnetic material and then with the phosphate compound.

4. The method of producing a coated magnetic material according to claim 1,
wherein the coating procedure is performed at least twice.

5. The method of producing a coated magnetic material according to claim 4,
wherein the coating procedure is performed at least n times where n is an integer of at least 2, and
wherein the aqueous solution used in the n-th coating procedure is obtained by adding the rare earth compound to the aqueous solution used in the (n−1)th coating procedure.

6. The method of producing a coated magnetic material according to claim 4,
wherein the coating procedure is performed at least m times where m is an integer of at least 2, and
wherein a pH of a mixture of the aqueous solution and the magnetic material obtained in the m-th coating procedure is lower than a pH of a mixture of the aqueous solution and the magnetic material obtained in the (m−1)th coating procedure.

7. The method of producing a coated magnetic material according to claim 6,
wherein in the m-th coating procedure, an inorganic acid is added to the aqueous solution to adjust a pH of the aqueous solution to at least 1 but not higher than 4.5.

8. The method of producing a coated magnetic material according to claim 7,
wherein in the m-th coating procedure, the pH of the aqueous solution is adjusted for at least 10 minutes.

9. The method of producing a coated magnetic material according to claim 1,
wherein the coating procedure is a primary coating procedure, and the primary coating procedure is followed by a secondary coating procedure comprising mixing an aqueous solution containing a phosphate compound and a non-rare earth metal element compound with the magnetic material resulting from the primary coating procedure to form a second coating containing phosphate and the non-rare earth metal element on the surface of the magnetic material resulting from the primary coating procedure.

10. The method of producing a coated magnetic material according to claim 9,
wherein the non-rare earth metal element compound is a metal oxoacid compound.

11. The method of producing a coated magnetic material according to claim 9,
wherein in the secondary coating procedure, an inorganic acid is added to the aqueous solution to adjust a pH of the aqueous solution to at least 1 but not higher than 4.5.

12. A method of producing a molded product, comprising:
obtaining a coated magnetic material by the method according to claim 1; and
heating the coated magnetic material.

13. The method of producing a molded product according to claim 12,
wherein the heating is preceded by pressurizing the coated magnetic material to obtain a pressure molded product, and
the heating comprises heating the pressure molded product.

14. A coated magnetic material, comprising:
a soft magnetic material; and
a coating containing a rare earth metal element, phosphorus, and oxygen provided on a surface of the soft magnetic material.

15. The coated magnetic material according to claim 14,
wherein in the coating, the oxygen is present in a larger amount than the phosphorus is.

16. The coated magnetic material according to claim 14,
wherein the coating further contains iron.

17. The coated magnetic material according to claim 14,
wherein the coating contains a non-rare earth metal element different from phosphorus or oxygen, and
the non-rare earth metal element and the rare earth metal element are present in the coating such that, in a direction from a surface of the coating toward the magnetic material, the non-rare earth metal element shows a maximum amount, and then the rare earth metal element shows a maximum amount.

18. The coated magnetic material according to claim 17,
wherein after the non-rare earth metal element shows the maximum amount, its amount decreases and then turns into an increase in the direction from the surface of the coating toward the magnetic material.

19. A molded product, comprising the coated magnetic material according to claim 14.
